(19) United States
(12) Patent Application Publication
(10) Pub. No.: US 2011/0262790 A1
(43) Pub. Date: Oct. 27, 2011

(54) COIN BATTERY HOLDER WITH IMPROVED TERMINAL

(75) Inventor: YU ZHU, Shenzhen (CN)

(73) Assignee: HON HAI PRECISION INDUSTRY CO., LTD., Tu-Cheng (TW)

(21) Appl. No.: 12/898,733

(22) Filed: Oct. 6, 2010

(30) Foreign Application Priority Data
Apr. 23, 2010 (CN) 201020168632.6

(51) Int. Cl. H01M 2/10

(52) U.S. Cl. 429/100

(57) ABSTRACT

A battery holder includes an insulative housing, a positive terminal and a negative terminal. The insulative housing defines a bottom wall and a peripheral wall commonly defining a battery receiving space. The positive terminal secured in the peripheral wall includes a retention portion, a folded portion upwardly bent from a bottom edge of the retention portion, a tail portion downwardly extending from the bottom edge of the retention portion and a pair of resilient arm portions respectively extending from one side edge of the retention portion and the folded portion to expose to the receiving space. The negative terminal secured in the bottom wall includes a contacting arm upwardly and obliquely extending in the receiving space.

### BACKGROUND OF THE INVENTION

1. Field of the Invention

The present invention relates generally to a battery connector, and more particularly to a battery holder for a coin battery.

2. Description of Related Art

U.S. Pat. No. 7,597,585 issued to Wei Yuan et al. on Oct. 6, 2009 discloses a conventional battery connector comprising an insulative housing, a positive terminal and a negative terminal respectively secured in the housing. The insulative housing defines a base and a peripheral wall extending upwardly from the base. The positive terminal positioned in the peripheral wall comprises a retention portion retained in the peripheral wall, a pair of resilient arm portions respectively extending from two sides of the retention portion. However, the structure of the positive terminal would lead to waste of material.

Hence, it is desired to provide a battery holder to overcome the problems mentioned above.

### BRIEF SUMMARY OF THE INVENTION

A battery holder comprises an insulative housing, a positive terminal and a negative terminal. The insulative housing defines a bottom wall and a peripheral wall commonly defining a battery receiving space. The positive terminal secured in the peripheral wall comprises a retention portion, a folded portion upwardly bent from a bottom edge of the retention portion, a tail portion downwardly extending from the bottom edge of the retention portion and a pair of resilient arm portions respectively extending from one side edge of the retention portion and the folded portion to expose to the receiving space. The negative terminal secured in the bottom wall comprises a contacting arm upwardly and obliquely extending in the receiving space.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a top perspective view of an battery holder according to the present invention;

FIG. 2 is bottom perspective view of the battery holder shown in FIG. 1;

FIG. 3 is an exploded view of the battery holder shown in FIG. 1;

FIG. 4 is a perspective view of a positive terminal of the battery holder in FIG. 3;

### DETAILED DESCRIPTION OF THE PREFERRED EMBODIMENT

Reference will be made to the drawing figures to describe the present invention in detail, wherein depicted elements are not necessarily shown to scale and wherein like of similar elements are designated by same or similar reference numeral through the several views and same or similar terminology.

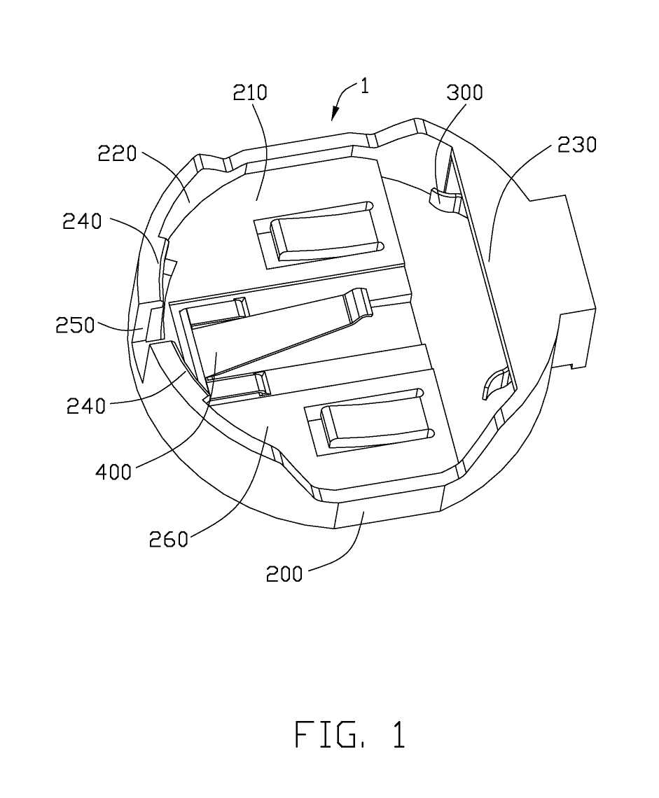

Referring to FIG. 1, a battery holder 1 for a coin battery (not shown) is shown according to a preferred embodiment of the present invention. The battery holder 1 comprises an insulative housing 200, a positive terminal 300 and a negative terminal 400.

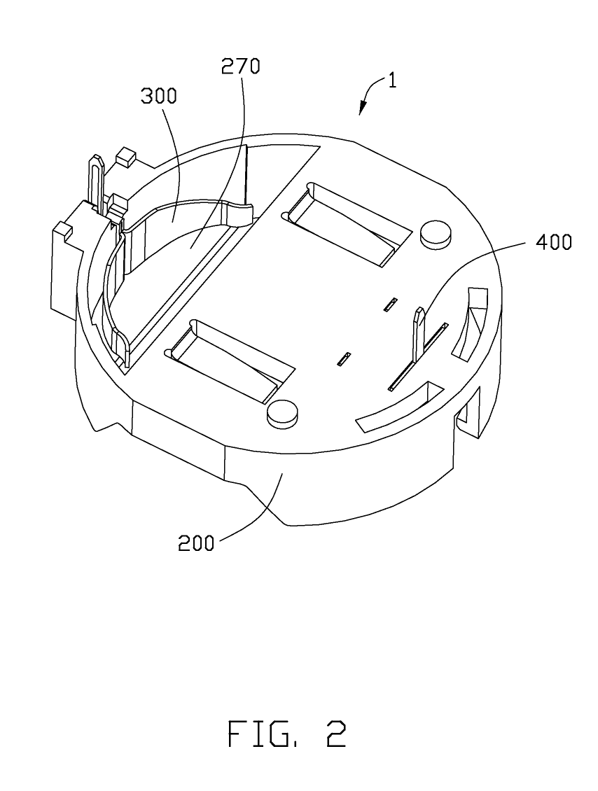

Referring to FIGS. 1-3, the insulative housing 200 is of circular shape, and comprises a bottom wall 210 and a ring peripheral wall 220 commonly defining a battery receiving space 260. The positive terminal 300 is secured in the peripheral wall 220 of the housing 200. The negative terminal 400 is secured in the bottom wall 210 of the housing 200. The insulative housing 200 further comprises a stop portion 230 located above the positive terminal 300. The stop portion 230 is parallel to the bottom wall 210. A pair of latch portions 240 is formed in the peripheral wall 220 and oppositely cooperates with the stop portion 230 to position the coin battery within the receiving space 260. A cutout 270 is formed in the bottom wall 210 and corresponds to the stop portion 230 so that the positive terminal 300 is assembled to the peripheral wall 220. A slot 250 is form in tip end of the peripheral wall 220 and located between the two latch portions 240 so as to provide the peripheral wall with elasticity to unload the coin battery.

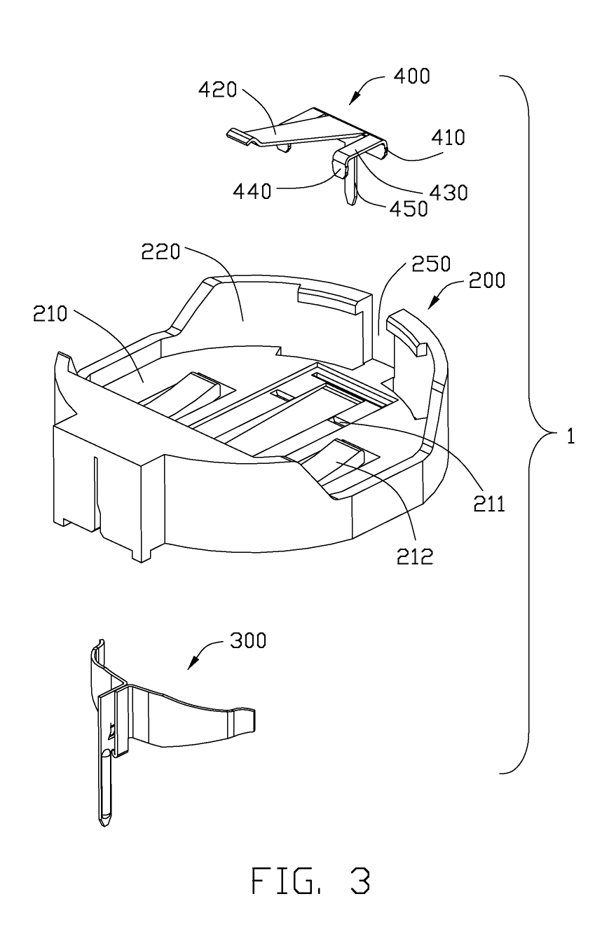

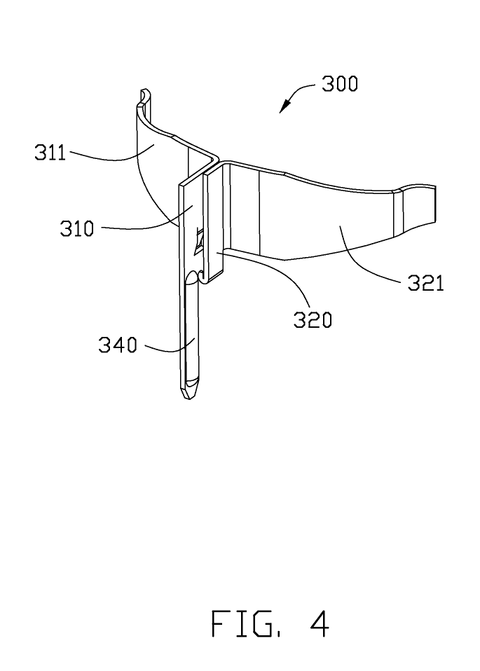

Referring to FIGS. 3 and 4, the positive terminal 300 comprises a retention portion 310, a folded portion 320 upwardly bent form inner half bottom edge of the retention portion 310, a tail portion 340 downwardly extending from outer half bottom edge of the retention portion 310 and a pair of resilient arm portions 311, 321 respectively extending from inner side edges of the retention portion 310 and the folded portion 320. The folded portion 320 intimately and side-by side contacts the retention portion 310. The retention portion 310 and the folded portion 320 are retained in passageway of the peripheral wall 220 so as to secure the positive terminal 300 in the insulative housing 200. The tail portion 340 extends beyond bottom surface of the bottom wall 210. The resilient arm portions 311, 321 are of arc shape and extend adjacent the peripheral wall 220. When the coin battery is received in the receiving space, the resilient arm portions 311, 321 engage with side surface of the coin battery so as to form a positive-electrode electrical connection to the coin battery.

Referring to FIG. 3, the negative terminal 400 is secured in the bottom wall 210. The negative terminal 400 comprises a retention portion 410, a tail portion 450 extending from bottom edge of the retention portion 410 and a contacting arm 420 upwardly and obliquely extending into the receiving space 260. The negative terminal 400 further comprises a pair of positioning portions 430 extending horizontally from upper edge of the retention portion 410. The contacting arm 420 is located between the positioning portions 430. Two craws 440 are downwardly bent from free ends of the positioning portions 430. Two slits 211 penetrate through the bottom wall 210 of the housing 200 so as to receive the two craws 440 of the negative terminal 400. Therefore, the negative terminal 400 is securely retained in the bottom wall 210 of the insulative housing 200. A pair of spring arms 212 unitarily extends upwardly and obliquely from the bottom wall. When the coin battery is received in the receiving space 260 of the housing 200, the spring arms 212 cooperate with the negative terminal 400 to result in a compound upward force upon the coin battery, thereby forming a negative-electrode electrical connection to the coin battery.

Referring to FIG. 3, in assembly, the positive terminal 300 is assembled to the insulative housing 200 from bottom to top, and the negative terminal 400 is assembled to the insulative housing 200 from top to bottom.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A battery holder comprising:
an insulative housing defining a bottom wall and a peripheral wall commonly defining a battery receiving space;
a positive terminal secured in the peripheral wall, the positive terminal comprising a retention portion, a folded portion upwardly bent from a bottom edge of the retention portion, a tail portion downwardly extending from the bottom edge of the retention portion and a pair of resilient arm portions respectively extending from one side edge of the retention portion and the folded portion to expose to the receiving space; and
a negative terminal secured in the bottom wall with a contacting arm upwardly and obliquely extending in the receiving space.

2. The battery holder as claimed in claim 1, wherein the retention portion is intimately next to the folded portion and received in a passageway defined in the peripheral wall.

3. The battery holder as claimed in claim 2, wherein the retention defines a tab projecting opposite to the folded portion.

4. The battery holder as claimed in claim 3, wherein the folded portion is disposed at an inner half bottom edge of the retention portion relative to the receiving space while the tail portion at an outer half bottom edge of the retention portion

5. The battery holder as claimed in claim 4, wherein the negative terminal comprises a retention portion, a tail portion downwardly extending from a bottom edge of the retention portion, said contacting arm extending from an upper edge of the retention portion.

6. The battery holder as claimed in claim 5, wherein the negative terminal further comprises a pair of positioning portions extending horizontally from the upper edge of the retention portion, said contacting arm is located between the positioning portions.

7. A battery holder comprising:
an insulative housing having a bottom wall and a peripheral wall commonly defining a battery receiving space;
a positive contact disposed at a specific position of the peripheral wall and defining a vertical retention portion, a folded portion linked to said retention portion and further horizontally facing said retention portion, a first resilient arm extending from an inward edge of the retention portion into the battery receiving space and essentially along said peripheral wall, a second resilient arm extending from an inward edge of the folded portion into the battery receiving space and essentially along said peripheral wall opposite to said first resilient arm, and a tail extending from the retention portion opposite to said first and second resilient arm for mounting to a printed circuit board; and
a negative contact disposed on the bottom wall with a resilient arm extending upward into the battery receiving space.

8. The battery holder as claimed in claim 7, wherein said folded portion is parallel to said retention portion.

9. The battery holder as claimed in claim 8, wherein said folded portion intimately faces said retention portion without gap.

10. The battery holder as claimed in claim 7, wherein said tail extends downwardly beyond the bottom wall of the housing.

11. The battery holder as claimed in claim 7, wherein said retention portion and the folded portion are linked to each other at bottom ends, respectively.

12. The battery holder as claimed in claim 11, wherein said tail extends downwardly beyond the bottom wall of the housing under condition that before folded to intimately face the retention portion, said folded portion is located at an inner side of the tail in a coplanar manner.

13. The batter holder as claimed in claim 12, wherein before folded and bent, the first resilient arm and the second resilient arm are side by side, in a vertical direction, arranged in a coplanar manner inside said retention portion under condition that said first resilient arm and said second resilient arm extend in a horizontal direction perpendicular to said vertical direction.

14. The batter holder as claimed in claim 7, wherein the retention portion lies in a vertical plane which essentially passes through a center of said battery receiving space.

15. The battery holder as claimed in claim 7, wherein before the positive contact is folded and bent while still linked to a contact carrier, the first resilient arm and the second resilient arm extend in a direction perpendicular to said contact carrier.

16. The battery holder as claimed in claim 15, wherein said tail extends downwardly with regard to the housing while extending in a direction parallel to the contact carrier before disconnected from the contact carrier.

17. A battery holder comprising:
an insulative housing having a bottom wall and a peripheral wall commonly defining a battery receiving space;
a positive contact disposed at a specific position of the peripheral wall and defining a U-shaped structure having two upstanding arms thereof, a pair of resilient arms extending from inner edge of the corresponding upstanding arms, respectively, and extending into the battery receiving space and essentially along the peripheral wall in opposite directions; and a tail linked on an outer edge of the U-shaped structure for mounting to a printed circuit board; and
negative contact disposed on the bottom wall with a resilient arm extending upward into the battery receiving space.

18. The battery holder as claimed in claim 17, wherein said tail is linked to one of the upstanding arms.

19. The battery holder as claimed in claim 17, wherein one of said upstanding arms performs a retention function.

20. The battery holder as claimed in claim 17, wherein said U-shaped structure is upstanding and the two upstanding arms intimately contact each other without a gap therebetween.
